(19) United States
(12) Patent Application Publication
(10) Pub. No.: US 2010/0140303 A1
(43) Pub. Date: Jun. 10, 2010

(54) Self-adjusting weighted fluid pick-up head for use with a standard fluid extraction tube associated with a spray bottle

(76) Inventor: Henry George Baglin, Sparks, NV (US)

Correspondence Address: Henry G. Baglin, 1094 Greenbrae Dr., Sparks, NV, 89434, US

(21) Appl. No.: 12/315,901

(22) Filed: Dec. 8, 2008

(51) Int. Cl. B67D 5/60

(52) U.S. Cl. 222/464.4

(57) ABSTRACT

A self-adjusting weighted fluid pick-up head for use with a standard fluid extraction tube associated with a spray bottle. Within the first embodiment, the pick-up head is of simple construction having a longitudinal internal bore there through which is of a size and shape to slid ably receive the lower fluid receiving end of a prior art fluid extraction tube therein and is slid ably engaged thereon between numerous positions depending upon the angle of the prior art spray bottle when held by the user. In a second embodiment, the pick-up head further includes use of an 0-ring which functions as a stop means.

### FIELD OF THE INVENTION

The present invention relates in general to pick-up heads that are attachable onto a fluid extraction tube typically provided within most spray bottles. More particularly the invention pertains to a simplified pick-up head that allows the consumer after purchase to easily modify any standard spray bottle having a typical extraction tube. Whereby, when modified utilizing the present invention upon manual manipulation (of the spray bottle between various tilted positions) the pick-up head in combination with the typical extraction tube automatically assume the most efficient location, resulting in substantially any remaining fluid in the bottle to be easily completely dispensed there from. Furthermore the present invention can be manufactured and/or sold as a kit having simplified components for modification of any standard bottle/extension tube and the components are re-usable again and again with different spray bottles of user choice.

### BACKGROUND OF THE INVENTION

Within the known prior art there have been numerous types of fluid dispensing apparatuses that rely on a fluid extraction tube for enabling fluid within a spray bottle to be extracted. Examples of such types of fluid dispensing apparatuses include manual-pump atomizing fluid dispensers, manual pump non-atomizing fluid dispensers, aerosol spray dispensers, hose-end fluid dispensers and the like. In these types of fluid dispensing apparatuses, the fluid extraction tube is attached to a body of the fluid dispensing apparatus, the body is attached to a neck portion of the spray bottle and the fluid extraction tube extends downwardly/inwardly into the fluid reservoir of the spray bottle. Upon a pressure differential being created throughout the fluid extraction tube via the fluid dispenser body, fluid is communicated from within the reservoir upwardly into the extraction tube, into the fluid dispenser body and outwardly from within the spray bottle container.

It is typical for these types of fluid dispensing apparatuses to be used in a tilted orientation such as (upward, downward, or sideways). In such a tilted orientation, due to gravitation fluid within the spray bottle settles at the lowest point of the fluid reservoir, which is substantially a corner lowermost region of the spray bottle when manually tilted. A conventional type of fluid extraction tube is typically made from a relatively stiff plastic material and extends downward into the reservoir. However, due to the length and stiffness of the tube, when the spray bottle is manually tilted not all of the fluid can be extracted from within the reservoir. As a result, the remaining fluid is only retrievable if the user removes the fluid dispenser body with the extraction tube, turns the spray bottle upside down and then pours the remaining fluid out from within the reservoir. Whereby, the remaining fluid cannot be sprayed but must be poured defeating the purpose of the spray bottle. This is most time consuming and frustrating thus the average consumer most often disposes of the spray bottle with the remaining fluid therein. Therefore, the current types of extraction tubes are wasteful and costly to use.

To overcome the limitations and inefficiency of the standard extraction tube the following patents address possible solutions to the problem. However, each have inherent drawbacks and disadvantages which the present invention clearly resolves in a simplified manner heretofore not taught. Examples of the prior art include U.S. Patent #2003/0218030 wherein disclosed is a replacement flaccid extraction tube having a fixedly attached weight upon the fluid pick up end. U.S. Patent #2004/0056052 discloses an elongated extraction tube having a fixedly attached weight upon the fluid pick up end. U.S. Pat. No. 5,195,664 discloses a first top stiff tube interconnected onto a second flexible tube and the second flexible tube has a weight fixedly attached thereon. U.S. Pat. No. 6,837,404 discloses a very flexible tube having an elongated fixedly attached weight thereon. U.S. Pat. No. 7,240,810 discloses another type of extension tube and weight mechanism that includes numerous parts and is very complicated.

Each of these references are somewhat functional for their intended use but they all have one common inherent disadvantage which the present invention recognizes, addresses and resolves in a manner heretofore not taught. Namely, in each reference they must replace the standard extension tube with a modified extension tube and also in each reference the weight is fixedly attached onto the tube. These disadvantages are most important. Namely, the need to replace the existing extension tube is costly, time-consuming and problematic. Also, it is unlikely that the modified extension tube would be functional with variable types of spray nozzles due to the modified length, size and shape. It is to be noted there are typically only two sizes of extension tubes utilized within currently available spray bottles. This is an advantage for the manufactures as there is no need to purchase specialized extension tubes which can be costly. The present invention can be sold and manufactured as a kit having all the necessary components to modify any standard spray bottle and/or extension tube. The only components required are two weights and two O-rings and this allows the consumer to easily modify any spray bottle of their choice and also the components can be re-used over and over again. The present invention is attachable to any standard fluid extension tube and eliminates the need for any modification thereof. More importantly, the novel weighted pickup-head of the present invention is slid ably engaged (not fixedly attached) onto the fluid extension tube and this allows the pickup-head to self-adjust and extend into the lowermost region of the fluid reservoir. Thus, substantially any and all remaining fluid therein can be extracted and utilized in a simplified manner. Therefore, the present invention is a novel and great advancement in this field and resolves all of the disadvantages associated with the prior art.

### OBJECTS AND ADVANTAGES OF THE PRESENT INVENTION

It is therefore a primary object of the present invention to provide a new and novel pick-up head that is slid ably attached onto any typical fluid extension tube associated with a standard spray bottle. Whereby the pick-up head is self-adjusting and when a user manually tilts the spray bottle, the pick-up head automatically assumes the most efficient position, namely, the lowermost region of the fluid reservoir and easily extracts any and all remaining fluid. Thus eliminating the need to open and pour the remaining fluid there from which is standard practice with all spray bottles currently available. Most consumers simply discard the remaining fluid along with the spray bottle as it is much too time-consuming and frustrating to open and pour the contents there from. Thus, the present is cost-efficient, environmentally friendly, eliminates waste and encourages the consumer to re-use the invention repeatedly with other spray bottles of user choice.

A further object of the present invention is to provide a kit having all of the necessary components therewith for easily converting any spray bottle of user choice. Namely, two weights and two O-rings of different sizes and that is all that is required.

Yet another object of the present invention is to provide a kit that allows the consumer to install the pick-up head without the need for any tools whatsoever. Furthermore, the kit includes extremely easy-to-follow instructions and no specialized skills are required.

Other objects and advantages will be seen when taken into consideration with the following specification and drawings.

### BRIEF DESCRIPTION OF THE DRAWINGS

FIG. 1 is substantially a perspective plan view illustrating the general concept and functional perimeters for the present invention.

FIG. 2 is substantially a partial front view depicting the present invention when orientated into a left side position.

FIG. 3 is substantially a partial front view depicting the present invention when orientated into substantially a centralized position.

FIG. 4 is substantially a partial front view depicting the present invention when orientated into a right side position.

### DETAILED DESCRIPTION OF THE DRAWINGS

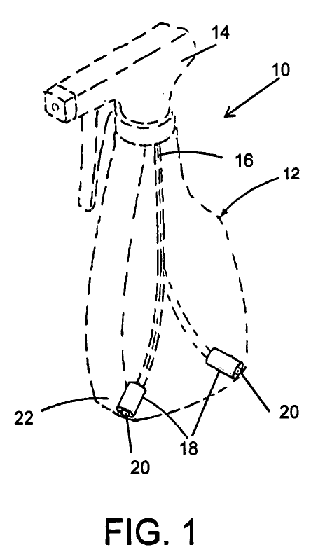

Referring now in detail to the drawings wherein like characters refer to like elements throughout the various views. In reference to FIG. 1 and as depicted therein, (10) represents an overview of a standard spray bottle (12) having standard components associated therewith. Namely, the spray bottle container (12), a fluid nozzle dispenser head (14) and a fluid extraction tube (16) interconnected onto the fluid dispenser head (14). All of which are depicted in ghost lines as these components represent existing prior art.

Further depicted in FIG. 1 is the self-adjusting weighted fluid pick-up head (18) which is the overall component respectively of the present invention. Namely, the self-adjusting fluid pick-up head (18) comprising of an elongated cylindrical pick-up head having a longitudinal internal bore (20) there through and the longitudinal internal bore (20) is of a size and shape to slid ably receive the lower fluid receiving end of the prior art fluid extraction tube therein. Whereby, when the spray bottle container (12) is manually manipulated into either in an upright vertical position or tilted to one side or the other, the elongated cylindrical pick-up head (18) gravitationally automatically slid ably self-adjusts upward or downward upon the prior art fluid extraction tube (16) into a lowermost position within the fluid reservoir (22) of the prior art spray bottle container (12). Thus any remaining fluid (not shown) within the fluid reservoir (22) can be extracted there from via the cylindrical pick-up head (18) and the prior art fluid extraction tube (16) in combination.

It is to be understood the above specification describes a first embodiment for the present invention and is simply an elongated cylindrical pick-up head (18) having the longitudinal internal bore (20) there through. It is to be further understood the present invention is fully functional and most efficient with only this one component. This embodiment allows any prior art spray bottle to be easily modified by a consumer and is usable over and over again with different spray bottles of user choice. The modification process requires the user to first remove the fluid nozzle dispenser head (14) along with the fluid extraction tube (16). Secondly, the user manually inserts the fluid extraction tube (16) into the longitudinal internal bore (20) until the self-adjusting weighted fluid pick-up head (18) rests against the fluid nozzle dispenser head (14) and the user holds momentarily in place. Thirdly, the user aligns the fluid nozzle dispenser head (14) with the fluid extraction tube (16) and the self-adjusting weighted fluid pick-up head (18) above the opening into the fluid reservoir (22) and releases the self-adjusting weighted fluid pick-up head (18) while simultaneously inserting the fluid extraction tube (16) into the fluid reservoir (22) and then re-attaches the fluid nozzle dispenser head (14) in the normal manner. During this third step the self-adjusting weighted fluid pick-up head (18) gravitationally assumes the proper position for fluid extraction on the bottom surface of the fluid reservoir respectively.

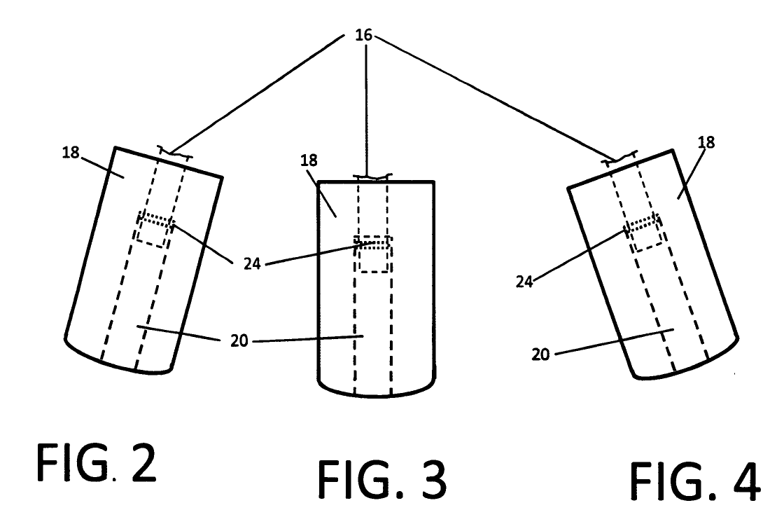

As noted the above first embodiment is fully functional when installed. However, the user may find that during the installation process the self-adjusting weighted fluid pick-up head (18) may accidentally become disengaged from the fluid extraction tube (16) before reattachment of the fluid nozzle dispenser head (14). To resolve this issue FIGS. 2-3 illustrate a second embodiment for the present invention wherein the longitudinal internal bore(20) is of a size and shape to slid ably frictionally retain an O-ring (24) therein and the O-ring being of a size and shape to slid ably receive the lower fluid receiving end of said fluid extraction tube (16) therein. Whereby; when the spray bottle container (12) is manually manipulated into either in an upright vertical position or tilted to one side or the other, the elongated cylindrical pick-up head (18) gravitationally automatically slid ably self-adjusts upward or downward upon the fluid extraction tube (16) into a lowermost position within the fluid reservoir (22) of the spray bottle container (12). Thus any remaining fluid (not shown) within the fluid reservoir (22) can be extracted there from via the cylindrical pick-up head (18) and the fluid extraction tube (16) in combination and the O-ring (24) simply functions as a stop means which eliminates the elongated cylindrical pick-up head (18) from disengagement from the fluid extraction tube (16) when the fluid extraction tube (16) is either manually inserted or removed from within said fluid reservoir during the installation process.

It is to be understood the elongated cylindrical pick-up head (18) during manual repositioning of the spray bottle container (12) automatically assumes numerous variable positions within the fluid reservoir and FIGS. 14 are only depictive of some variables for illustrative purposes. Thus the variable positions for the elongated cylindrical pick-up head (18) are not fully depicted herein and such variable positions are not to be limited thereto.

As depicted in FIG. 2, if the spray bottle container is tilted to the left respectively, the elongated cylindrical pick-up head (18) automatically assumes a position on the lowermost left region of the fluid reservoir (22). Thus, the elongated cylindrical pick-up head (18) automatically slides slightly downward upon the fluid extraction tube (16).

As depicted in FIG. 3, if the spray bottle container (12) is upright respectively, the elongated cylindrical pick-up head (18) automatically assumes a centralized position on the lowermost center region of the fluid reservoir (22). Thus, the elongated cylindrical pick-up head (18) automatically slides slightly upward upon the fluid extraction tube (16).

As depicted in FIG. 4, if the spray bottle container (12) is tilted to the right respectively, the elongated cylindrical pick-up head (18) automatically assumes a position on the lowermost right region of the fluid reservoir (22). Thus, the elongated cylindrical pick-up head (18) automatically slides slightly downward upon the fluid extraction tube (16).

As previously noted, it is to be understood that the present invention can be sold as a modification kit having one elongated cylindrical pick-up head (18) therein (with or without) an O-ring and an informational brochure providing modification instructions for the consumer. Or if preferred, the present invention can be sold as a modification kit having two elongated cylindrical pick-up heads (18) of various sizes, with or without two O-rings and an informational brochure providing modification instructions for the consumer. Therefore it is to be understood the components within the kit are of engineering choice and/or consumer preferences. Furthermore, it is to be understood the size and shape of the components, namely, the O-ring(s) and/or the elongated cylindrical pick-up head(s), (18) are not to be limited to the drawings herein as multiple variations are clearly inherent.

Although the invention has been herein shown and described in what is conceived to be the most practical and preferred embodiment, it is recognized that departures may be made there from within the scope and spirit of the invention, which is not to be limited to the details disclosed herein but is to be accorded the full scope of the claims so as to embrace any and all equivalent devices and apparatuses.

Having described the invention, what I claim as new and desire to secure by Letters Patent is:

1. A self-adjusting weighted fluid pick-up head for use with a standard fluid: extraction tube associated with a spray bottle comprising: an elongated cylindrical pick-up head having a longitudinal internal bore there through, said longitudinal internal bore being of a size and shape to slid ably receive the lower fluid receiving end of a fluid extraction tube therein;
whereby;
when said spray bottle is manually manipulated into either in an upright vertical position or tilted to one side or the other, said elongated cylindrical pick-up head gravitationally automatically slid ably self-adjusts upward or downward upon said fluid extraction tube into a lowermost position within the fluid reservoir of said spray bottle, thus any remaining fluid within said fluid reservoir can be extracted there from via said cylindrical pick-up head and said fluid extraction tube in combination.

2. A self-adjusting weighted fluid pick-up head for use with a standard fluid extraction tube associated with a spray bottle comprising: an elongated cylindrical pick-up head having a longitudinal internal bore there through, said longitudinal internal bore being of a size and shape to slid ably frictionally retain an O-ring therein and said O-ring being of a size and shape to slid ably receive said lower fluid receiving end of said fluid extraction tube therein;
whereby;
when said spray bottle is manually manipulated into either in an upright vertical position or tilted to one side or the other, said elongated cylindrical pick-up head gravitationally automatically slid ably self-adjusts upward or downward upon said fluid extraction tube into a lowermost position within the fluid reservoir of said spray bottle, thus any remaining fluid within said fluid reservoir can be extracted there from via said cylindrical pick-up head and said fluid extraction tube in combination and said O-ring functions as a stop means which eliminates said elongated cylindrical pick-up head from disengagement from said fluid extraction tube when said fluid extraction tube is either manually inserted or removed from within said fluid reservoir.
